(19) United States
(12) Patent Application Publication
(10) Pub. No.: US 2007/0275346 A1
(43) Pub. Date: Nov. 29, 2007

(54) Multilayer Articulating Foil

(76) Inventors: Werner Mannschedel, Langenau (DE); Barbara Muller, Langenau (DE)

Correspondence Address: KATTEN MUCHIN ROSENMAN LLP, 575 MADISON AVENUE, NEW YORK, NY, 10022-2585, US

(21) Appl. No.: 10/587,621

(22) PCT Filed: Jan. 31, 2005
(86) PCT No.: PCT/EP05/00920

§ 371 Date: May 4, 2007

(30) Foreign Application Priority Data
Jan. 29, 2004 (DE) 102004004560.7

(51) Int. Cl. A61C 9/00

(52) U.S. Cl. 433/70

(57) ABSTRACT

The present invention relates to an articulating aid for use in dentistry, which is characterised in that it has, on at least one side of a support layer, a plurality of differently coloured colour layers comprising colouring pigments and at least one adhesion promoter for at least one colouring pigment of at least one of the coloured colour layers

The present invention relates to the field of dentistry aids and relates to an articulating aid, especially an articulating paper for marking contact sites of teeth of a masticatory unit/occlusal unit.

In dentistry, the “masticatory unit” denotes the teeth of the upper and lower rows of teeth brought into engagement with one another when biting together. As distinct from that, the “occlusal unit” indicates the teeth of the upper and lower rows of teeth brought into engagement with one another in the case of relaxed closure of the jaw. In both cases, the teeth of the upper and lower rows are brought into contact with one another only at individual contact sites, that is to say not over their entire surface.

In dentistry, teeth damaged by caries are usually provided with fillings made of gold, ceramics, amalgam or synthetic material. Where a tooth is damaged to such an extent that a filling can no longer be used, in more extensive prosthetic measures so-called onlays, partial crowns or full crowns are applied to the tooth.

In such restorative dental treatment, it is important for the teeth to have a suitable bite again following treatment, that is to say it must be possible for the teeth of the upper and lower rows to be so pressed against one another by relaxed closure of the jaw or by muscular force that a bite of that kind is not adversely affected by individual contact sites that are “too high”, which may lead to muscular tension and other adverse health effects. In other words, the contact sites of a masticatory unit/occlusal unit should adjoin one another with a substantially equal pressure load. In the present invention, the “height” of a contact site denotes the distance of a contact site from the tooth apex in apical-basal direction.

The dentist is therefore faced with the problem that the bite generally needs to be realigned following a restorative treatment of teeth. In order to align the bite, the dentist uses thin, pliable articulating papers which, in a conventional arrangement thereof, consist of a support layer of plastics material with a colour layer applied thereto. The colour layer is usually a colour wax, such as, for example, vegetable carnauba wax, that comprises colouring pigments.

In practical use, those articulating papers are inserted between the teeth of the masticatory unit/occlusal unit containing the treated tooth and the patient is asked to make chewing movements. During the chewing movement, the colouring pigments of the colour layer of the articulating paper are rubbed off by the contact sites, so that the dentist is able, from the resulting colour marks on the tooth, to identify where the contact sites of the teeth of a masticatory unit/occlusal unit are located. If the contact sites are too high, that is to say when they prevent a suitable bite of the masticatory unit/occlusal unit, those contact sites are ground down to a suitable height or until the patient finally signals his agreement that the bite is comfortable.

A disadvantage in that, when the dentist uses a conventional articulating paper, he is given only one piece of information in respect of the location of the contact sites. When there is a plurality of contact sites, the dentist does not receive any information about the scale of the difference in height by which the height of a contact site exceeds the height suitable for a bite. If the patient indicates that the bite is still not correct, the dentist has to estimate, based on his experience, which of the coloured contact sites actually still has the greatest difference in height from the height suitable for it for the bite. In case of doubt, all of the contact sites need to be ground down until an acceptable bite has been established, which may then have the result that, although the highest contact site has been ground down to such an extent that it ensures an acceptable bite, other contact sites, in turn, are then too low for an optimum bite. In addition, even when a bite is accepted by the patient, the case may arise that a contact site in fact exceeds a height suitable for a bite, and that contact site is thus exposed, in a disadvantageous manner, to a local apical pressure load during biting. An optimally aligned bite, in which all contact sites of a masticatory unit/occlusal unit are located/pressed against one another with a substantially equal compressive force, cannot be brought about in a targeted manner and, accordingly, is generally merely a chance result based on the experience of the dentist.

The problem underlying the present invention is therefore to provide an improved articulating aid by means of which the above-mentioned disadvantages of the articulating papers available in the state of the art can be avoided.

That problem is solved in accordance with the invention by an articulating aid, especially an articulating paper, that corresponds to the features of the main claim. Advantageous developments of the invention are indicated in the sub-claims.

According to the proposal of the invention, the articulating aid, which includes a support layer, comprises for that purpose, on at least one side of the support layer, a plurality of differently coloured colour layers, for example 2, 3 or 4 such layers and at least one adhesion promoter for at least one colouring pigment of at least one of the coloured colour layers.

The function of the adhesion promoter is especially to impart, by means of adhesion, the force-based surface union between the colouring pigment(s) of at least one of the coloured colour layers and the teeth of the masticatory unit/occlusal unit containing the treated tooth. An adhesion promoter of that kind especially improves the adhesion of the colouring pigment(s) of the colour layer(s) to the teeth of the masticatory unit/occlusal unit. An adhesion promoter of that kind especially improves the adhesion of the colouring pigment(s) of at least one of the colour layers to the materials used in dental treatment, such as gold, ceramics, synthetic material or amalgam. In other words, the materials used to treat the tooth can readily be coloured using the articulating aid according to the invention by the use of an adhesion promoter, so that the contact sites of a masticatory unit/occlusal unit can be marked in a more secure and more reliable manner. The adhesion promoter in such an arrangement can be so selected that it improves the adhesion of individual colouring pigments only or of all colouring pigments of the colour layers to the materials used in the dental treatment. Different articulating aids may have different colours, for example according to the material to be coloured.

The plurality of differently coloured colour layers advantageously makes it possible for the relative height of a contact site with respect to the height of that contact site suitable for a bite to be ascertained in simple manner. Where the articulating aid has, for example, two differently coloured colour layers, for example a red first colour layer on the support material and a green second colour layer on the red first colour layer, after using the articulating aid the dentist is immediately able to identify, when there are green-coloured and red-coloured contact sites, that the red-coloured contact sites have a more intensive bite contact with the corresponding tooth/teeth of the masticatory unit/occlusal unit than the green-coloured contact sites. In other words, any red-coloured contact site is still too high with respect to a height of that contact site suitable for a bite and needs to be ground down to achieve a suitable bite. By repetition of the procedure by the dentist, it is possible, by successive grinding down of red-coloured contact sites, for a substantially uniform pressure load between the contact sites of a masticatory unit/occlusal unit to be achieved, that being indicated when only green-coloured contact sites still occur when the articulating aid according to the invention is used.

As an alternative, an articulating aid according to the invention may have an equal or different number of colour layers on both sides, the articulating aid having an adhesion promoter at least on one side. For example, an articulating aid according to the invention may have two differently coloured colour layers on one side, one of those colour layers comprising an adhesion promoter, and merely two differently coloured colour layers on the other side. It is also possible, however, for the adhesion promoter to be present in the form of a layer on one of the colour layers.

In an advantageous development of the invention, the colour layers have different layer thicknesses. Thus, where the layer thickness of the colour layers diminishes from the support material towards the uppermost colour layer, the dentist is able to establish a suitable height of a contact site very precisely. When the articulating aid is provided, for example, with three differently coloured colour layers, such as, for example, a red colour layer on the support layer having a large layer thickness in the range from 1 to 20 μm, a green colour layer on the red colour layer having a medium layer thickness in the range from 1 to 10 μm, and a yellow colour layer on the green colour layer having a small layer thickness in the range from 1 to 10 μm, then coloration of a contact site varies from red to green to yellow as the height increment diminishes.

The colouring pigments used in accordance with the invention are colouring pigments customary per se for articulating aids.

In an advantageous arrangement of the invention, the adhesion promoter is included in at least one colour layer. The adhesion promoter may, for example, be present in the colour layer in a suspended or dissolved form. In such an arrangement, the adhesion promoter may be inserted in one or more of the colour layers. Where the adhesion promoter is inserted in a plurality of colour layers, the adhesion promoter of one layer may be different from the adhesion promoter of another layer, in order, for example, suitably to match the adhesion-imparting property to the specific colouring pigments of a colour layer.

Alternatively, a layer comprising the adhesion promoter may be applied to at least one of the colour layers. In such an arrangement, either an adhesion-promoter layer may be applied to only one colour layer, or an adhesion promoter layer may be applied to each of a plurality of colour layers. Where there is a plurality of adhesion promoter layers, the adhesion promoter of one layer may be different from the adhesion promoter of another layer. In addition, an adhesion promoter may be inserted in one or more of the different colour layers. When the adhesion promoter is inserted in a plurality of colour layers, the adhesion promoter of one layer may be different from the adhesion promoter of another layer in order, for example, suitably to match the adhesion-imparting property to the specific colouring pigments of a colour layer.

Further, it is especially advantageous when the uppermost colour layer, that is, the colour layer the furthest removed from the support material, defines a tolerance height for contact sites of a masticatory unit/occlusal unit. In other words, when the contact sites of a masticatory unit are uniformly coloured by the uppermost colour layer only, the heights of the contact sites of the masticatory unit/occlusal unit lie within a tolerance measurement for a height of the contact sites appropriate for producing a suitable, anatomically acceptable bite. For example, the layer thickness of the uppermost colour layer in such an arrangement is from 5 to 10 μm, preferably from 7 to 9 μm, especially 8 μm.

In a preferred development of the invention, the adhesion promoter, which is either inserted into a colour layer or is applied to the colour layer in the form of an adhesion-promoter layer, is encapsulated in microcapsules. The encapsulation of substances in microcapsules is a technique familiar to the person skilled in the art which does not need to be described in detail herein. For example, such microcapsules contain ester wax and have a size of from 0.1 to 1000 μm; preferably, the microcapsules have a size in the range from 2 to 30 μm.

In an advantageous development of the microcapsules, the microcapsules are so formed that they release the adhesion promoter only as a result of the action of an activator. Preferably, the adhesion promoter is released by crushing the microcapsules containing the adhesion promoter by biting. This makes it possible for the adhesion promoter to be released only at the contact sites of the masticatory unit/occlusal unit at which a biting action occurs. It is likewise possible, and in accordance with the invention preferred, for the adhesion promoter to be released from the microcapsules only after UV irradiation of the microcapsules, by means of which the release of the adhesion promoter can be restricted to the area of the masticatory unit/occlusal unit. In that manner it is possible for the total amount of adhesion promoter to which the patient is exposed and which, in significant amounts, might possibly have an adverse effect on the health/well-being of the patient, to be kept to a minimum.

The colour layers of the articulating aid of the present invention may advantageously be coloured wax colour layers. Examples are: vegetable waxes (for example carnauba wax, montan wax), animal waxes (for example beeswax), mineral waxes (for example ceresin), petrochemical waxes (for example paraffin waxes, micro waxes) and chemically modified hard waxes (for example montan ester waxes, jojoba waxes), synthetic waxes (for example polyethylene glycol waxes).

The layer thickness of the colour layers may be dependent, for example, on the material of the colour layer, the layer thickness being from 0.1 to 30 μm, preferably from 1 to 20 μm, especially from 1 to 8 μm.

The adhesion promoter may be, for example, from the group of the natural resins (balsams, colophony, fossil resins), also carbohydrates (starch, dextrin, sugars), proteins (albumin, casein, gelatin), rubber (latex, dried latex, precipitated latex), waxes and other natural substances (beeswax, shellac, gum arabic), or synthetic adhesion promoters (for example methyl cellulose, polyvinyl alcohol, polyvinylpyrrolidone, polystyrene, polyvinyl chloride, polyacrylates, polymethacrylates, polyvinyl acetate, polyvinyl acetate polyethylene mixtures, nitrocellulose, polychloroprenes, rubbers, polyurethanes, methacrylates, cyanoacrylates, diacrylic acid esters, epoxy resins or polyesters.

The adhesion promoter has a tackiness that enables the adhesion promoter to impart the force-based surface union between the colouring pigment(s) of one of the coloured colour layers and the teeth of the masticatory unit/occlusal unit containing the treated tooth. The layer thickness of the individual adhesion-promoter layer can vary; it is, for example, from 0.1 to 5 μm, preferably from 2 to 4 μm and, most preferably, 3 μm.

The support layer of the articulating aid may consist of, or comprise, for example, polyvinyl chloride, polyethylene, polypropylene, PET or silicone. It is also possible for the support layer to consist of or comprise paper or woven fabrics, knitted fabrics or non-wovens. In the latter case, the pores of the support, especially of paper, are preferably impregnated with the colorant containing the colouring pigment. It is furthermore advantageous when the colour characteristic of the coating of the articulating aid having different adhesion promoters assumes a coding function, (for example yellow for amalgam, blue for composite, green for ceramics, black for gold), in order to simplify for the user identification of the materials that suit one another.

Referring to the accompanying drawing, the invention is explained in greater detail by way of an example embodiment.

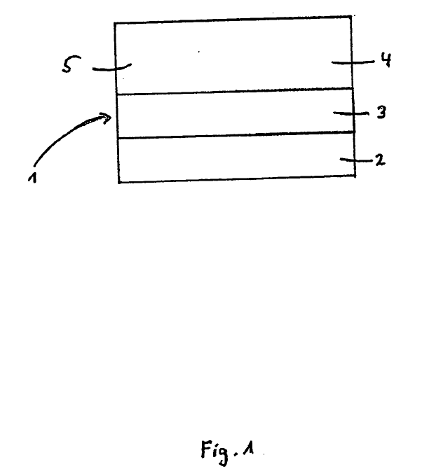

FIG. 1 is a diagrammatic cross-section of an example embodiment of the articulating paper according to the invention.

FIG. 1 is a diagrammatic cross-section of an example embodiment of the articulating paper 1 according to the invention. The articulating paper 1 comprises a support 2 of PVC, to which there is applied a first wax colour layer 3 consisting of a red-coloured carnauba wax. The thickness of the first wax colour layer 3 is 5 μm. Applied to the first wax colour layer 3 is a second wax colour layer 4 consisting of green-coloured carnauba wax, which layer comprises an adhesion promoter. The thickness of the second wax colour layer 4 is 8 μm. The wax colour layer 4 comprises, in addition, an adhesion promoter 5.

1. Articulating aid for use in dentistry, characterised in that it has, on at least one side of a support layer, a plurality of differently coloured colour layers comprising colouring pigments and at least one adhesion promoter for at least one colouring pigment of at least one of the coloured colour layers.

2. Articulating aid according to claim 1, characterised in that the at least one adhesion promoter is present in at least one of the colour layers.

3. Articulating aid according to claim 2, characterised in that an adhesion promoter is present in a plurality of colour layers.

4. Articulating aid according to claim 1, characterised in that a layer comprising the adhesion promoter is applied to at least one of the colour layers.

5. Articulating aid according to claim 4, characterised in that an adhesion promoter is present also in at least one of the colour layers.

6. Articulating aid according to claim 1, characterised in that the colour layers have different layer thicknesses.

7. Articulating aid according to claim 1, characterised in that the uppermost colour layer has a defined layer thickness which corresponds to the tolerance height for contact sites of a masticatory unit/occlusal unit.

8. Articulating aid according to claim 7, characterised in that the layer thickness of the uppermost colour layer is about 8 μm.

9. Articulating aid according to claim 1, characterised in that the adhesion promoter is encapsulated in microcapsules.

10. Articulating aid according to claim 9, characterised in that the microcapsules are suitable for releasing the adhesion promoter as a result of the action of pressure.

11. Articulating aid according to claim 9, characterised in that the microcapsules are suitable for releasing the adhesion promoter as a result of the action of an activator.

12. Articulating aid according to claim 11, characterised in that the microcapsules are suitable for releasing the adhesion promoter as a result of UV irradiation of the microcapsules.

13. Articulating aid according to claim 11, characterised in that the microcapsules are suitable for releasing the adhesion promoter as a result of the application of heat to the microcapsules.

14. Articulating aid according to claim 1, characterised in that the colour layers are coloured wax layers.
